(19) United States
(12) Patent Application Publication
(10) Pub. No.: US 2023/0060462 A1
(43) Pub. Date: Mar. 2, 2023

(54) DIGITAL STATUS TRACKING OF FUNDS

(71) Applicant: Royal Bank of Canada, Toronto (CA)

(72) Inventors: Aditya Subramanian, Waterloo (CA); Pei Si Jian, Toronto (CA); Wanze Zhang, Victoria (CA); Kartik Porwal, Hamilton (CA)

(21) Appl. No.: 17/897,094

(22) Filed: Aug. 26, 2022

Related U.S. Application Data
(60) Provisional application No. 63/237,686, filed on Aug. 27, 2021.

(51) Int. Cl. G06Q 20/10; G06Q 50/16; G06Q 20/42

(52) U.S. Cl. CPC G06Q 20/102; G06Q 20/42; G06Q 20/108; G06Q 50/163

(57) ABSTRACT

A method is provided for tracking funds in a real estate transaction using a real estate transaction portal. Through an interface of a real estate transaction portal, a request is accepted from a pre-registered buyer to transfer funds to a pre-registered beneficiary, the funds being in settlement of at least a portion of a real estate transaction. A corresponding payment request is initiated through a digital payment channel. On receipt of a first automated message through the payment channel, the first automated message is decoded as a confirmation of the initiation of the payment request. In real time, a graphical status indicator is displayed to the pre-registered buyer and the pre-registered beneficiary showing the initiation. On receipt of a second automated message through the payment channel, the second automated message is decoded as a completion of the payment request and the graphical status indicator is accordingly updated in real time.

### CROSS-REFERENCE TO RELATED APPLICATION

The present application claims priority to United States provisional application no. 63/237,686, filed on Aug. 27, 2021, and entitled “Multi-channel Status Tracking”, the entirety of which is hereby incorporated by reference.

### TECHNICAL FIELD

The present disclosure is directed at methods, systems, and techniques for automated digital status tracking of funds, including funds transferred through multiple payment channels.

### BACKGROUND

Certain types of transactions remain difficult to complete electronically. For example, one persistent headache of real estate transactions is the need for paper cheques or bank drafts to complete certain staged settlement payments. Typically, this entails multiple visits (for deposits and down payments) to a bank branch to order and pick up drafts. If multiple intermediaries are involved, such as realtors and lawyers for both buyer and seller, a payment once initiated can be difficult for all of the parties to track. Although various forms of digital payment exist and have increased in popularity, digital payments have largely not been taken up for real estate transactions due to worries about security, transparency and traceability.

Certified cheques and bank drafts are also frustrating for financial institutions, as they incur heavy processing costs with a highly manual process. Further, the fact that such transactions require in person attendance may entail health risk to personnel, by contrast to other banking transactions that can be performed remotely.

Other aspects of a real estate transaction have been automated, largely to facilitate document generation. Attempts have been made to provide, for example, online or private deal rooms, where lawyers (and/or realtors) can generate and collaborate on transaction documents. However, such systems have not included automated payment functionality.

Transaction clearing houses (and staging accounts or escrow) exist whereby payments can be made and timed through an intermediary. This can be advantageous from a tracking point of view, but adds complexity and additional parties, typically with attendant charges. Typically, such systems have not been used, for example, for real estate transactions.

### SUMMARY

According to a first aspect, a method is provided for tracking funds in a real estate transaction using a real estate transaction portal. Through an interface of a real estate transaction portal, a request is accepted from a pre-registered buyer to transfer funds to a pre-registered beneficiary, the funds being in settlement of at least a portion of a real estate transaction. A corresponding payment request is initiated through one of a plurality of digital payment channels. On receipt of a first automated message through the one of the plurality of digital payment channels, the first automated message is decoded as a confirmation of the initiation of the payment request. In real time, a graphical status indicator is displayed to the pre-registered buyer and the pre-registered beneficiary showing the initiation. On receipt of a second automated message through the one of the plurality of digital payment channels, the second automated message is decoded as a completion of the payment request. In real time, the graphical status indicator is modified to display to the pre-registered buyer and the pre-registered beneficiary that the payment has been completed.

For example, the payment channel may be selected from wire payment, Real Time Rail, Lynx, and LVTS.

For example, the automated messages may be in SWIFT or ISO encoding.

For example, the first automated message may include a PAIN.001 message and the second automated message may include a PAIN.002 message.

The decoding steps may include determining the encoding of the messages. This may include parsing a string into segments. The decoding steps may include conversion of one encoding to another. The decoding steps may include conversion into a human readable message.

Preferably, the graphical status indicator includes at least one colour. The colour of at least a portion of the graphical status indicator may be changed or filled in as the automated messages are received.

The method may further include displaying at least one textual message in human readable terms with the graphical status indicator.

The method may further include receiving particulars of the real estate transaction through the interface, including a settlement amount, and pre-verifying the particulars or the settlement amount prior to allowing the funds transfer request to be received. For example, the beneficiary may be pre-verified by validating a link of the beneficiary to a valid bank account. For example, the buyer may be pre-verified by: validating a link of the buyer to a valid bank account; and/or validating that the buyer’s bank account includes sufficient funds to cover the settlement amount.

The request to transfer funds may be signaled by response to a prepopulated request form, the form including the settlement amount. The form may also include prepopulated references to the buyer’s bank account and the beneficiary’s bank account.

The one of the plurality of digital payment channels may be selected based on an amount of the funds. For example, if the value being transferred is less than a certain threshold (e.g., $25,000), one type of digital payment channel may be used (e.g., Lynx); and if the value being transferred is more than that threshold, a different digital payment channel may be used (e.g., Real Time Rail).

The interface of the real estate transaction portal may be displayed on a first system terminal (e.g., used by a lawyer), and the graphical status indicator may be displayed to the pre-registered buyer and pre-registered beneficiary on respective second and third system terminals.

According to a second aspect, there is provided a system for tracking funds in a transaction using a real estate transaction portal. The system comprises first through third system terminals, which may be used for example by a pre-registered buyer, a pre-registered beneficiary, and a lawyer or realtor facilitating the real estate transaction. The system also comprises one or more servers configured to, through an interface of the real estate transaction portal displayed on the first system terminal, accept a request from a pre-registered buyer to transfer funds to a pre-registered beneficiary, the funds being in settlement of at least a portion of the real estate transaction; initiate a corresponding payment request through one of a plurality of digital payment channels; on receipt of a first automated message through the one of the plurality of digital payment channels, decode the first automated message as a confirmation of the initiation of the payment request; in real time, display to the pre-registered buyer and the pre-registered beneficiary on the second and third system terminals, respectively, a graphical status indicator showing the initiation; on receipt of a second automated message through the one of the plurality of digital payment channels, decode the second automated message as a completion of the payment request; and in real time, modify the graphical status indicator to display to the pre-registered buyer and the pre-registered beneficiary that the payment has been completed.

According to third aspect, there is provided a non-transitory computer readable medium having stored thereon computer program code that is executable by a processor and that, when executed by the processor, causes the processor to perform the above described method for tracking funds in a transaction using a real estate transaction portal.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a network diagram illustrating one architecture used to implement a system for digital status tracking of funds, according to an example embodiment.

FIG. 2 is a block diagram of a server comprising part of the architecture of FIG. 1.

FIG. 3 is a data flow diagram illustrating a flow structure from user registration to end of a deal, according to an example embodiment.

FIGS. 4A and 4B collectively depict a flow diagram showing a payment flow from registration to payment receipt, according to an example embodiment.

FIGS. 5A and 5B are payment flow diagrams at a technical level for SWIFT/LVTS and ISO/Lynx, respectively, according to example embodiments.

FIG. 6 is a sample screen shot of a portal dashboard for a new real estate transaction showing payment status unlit, according to an example embodiment.

FIG. 7 is a sample screen shot of a workspace providing a “make a payment” option for the real estate transaction referenced in FIG. 6.

FIG. 8 is a sample screen shot of a “payment request” prepopulated with particulars of a sample deposit for the real estate transaction (with a “pay now” option) referenced in FIG. 6.

FIG. 9 is a sample screen shot of a “pay now” screen showing account and amount particulars (with a “submit” option) for the real estate transaction referenced in FIG. 6.

FIG. 10 is a sample screen shot of the portal dashboard of FIG. 6 now showing “deposit sent”.

FIG. 11 is a sample screen shot of the portal dashboard of FIG. 6 now showing “deposit received”.

FIG. 12 is a sample screen shot of a similar dashboard on the portal for lawyers and/or realtors showing deposit and down payment sent and received.

FIG. 13 is a flow diagram of a generalized method of funds transfer enabled through the portal illustrated in FIGS. 6-11.

FIG. 14 is a block diagram of a system for digital status tracking of funds illustrating the technology stack used to implement the system, according to an example embodiment.

### DETAILED DESCRIPTION

It would be beneficial to have a platform to facilitate electronic completion of types of transactions that, for reasons such as security, transparency and traceability, have to date remained completed in paper. Generally, these types of transactions are typically for large dollar amounts where proceeds are certified and where payment passes through a trusted intermediary. One example of this type of transaction is a real estate transaction, in which completing a transaction typically involves three parties: a buyer, a seller, and a trustee through whom sales proceeds flow.

In respect of a real estate transaction in particular, a platform may include portal functionality allowing collaboration on the document aspects of the transaction. It would be desirable as well to provide automated payment functionality and status updates on such payments to remove or lessen concerns as to security, transparency and traceability. However, in order to be most convenient and reliable, such a system should take advantage of automated messaging in payment systems to avoid the introduction of errors and delay through manual status updating. It would be desirable to adapt to various payment channels, which each have their own messaging.

In at least some embodiments herein, methods, systems, and techniques are provided for automated digital status tracking of funds, including through multiple payment channels. For real estate transactions in particular, an interactive real estate transaction portal system is provided which enables direct initiation and tracking of funds transfer as a part of a real estate transaction. The portal is preferably limited to a closed community of pre-verified participants having pre-verified account details, so that payments are easily initiated. Tracking is made possible by translating payment status in real time from the automated payment channel messages, which may be from diverse channels of digital payment.

This information may be used by buyers, sellers and their representatives (e.g. lawyers, realtors) to instill confidence in the timing and accuracy of the payments at staged intervals in the transaction.

In at least some embodiments, the portal contains dashboard and workspace areas and direct payment initiation functionality. The product (or suite) allows for streamlined transfer and acquisition in a real estate transaction by accessing digital payment channels that are convenient, secure, quick and traceable along with collaborative features which alleviate pain points of multiple stakeholders. From a bank perspective, the system also permits reduced reliance on paper cheques for real estate clients, the second largest demographic of cheque users.

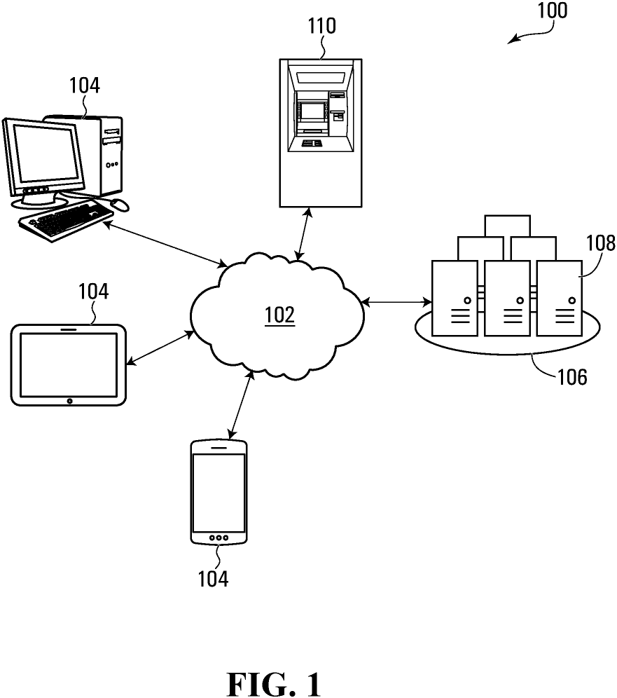

The tool is in at least some embodiments part of a network environment, which may take various configurations. Referring now to FIG. 1, there is shown a computer network 100 that comprises an example embodiment of a system for digital status tracking of funds, which permits automated status tracking of funds through multiple payment channels. More particularly, the computer network 100 comprises a wide area network 102 such as the Internet to which various user devices 104, a system terminal 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as managing investment portfolios.

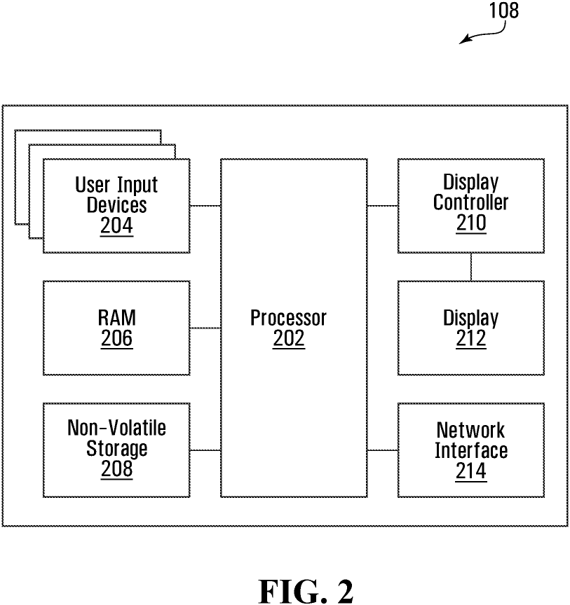

Referring now to FIG. 2, there is depicted an example embodiment of one of the servers 108 that comprises the data center 106. The server comprises a processor 202 that controls the server’s 108 overall operation. The processor 202 is communicatively coupled to and controls several subsystems. These subsystems comprise user input devices 204, which may comprise, for example, any one or more of a keyboard, mouse, touch screen, and microphone; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for digital status tracking of funds, such as described further below. Additionally or alternatively, the servers 108 may collectively perform that method using distributed computing. While the system depicted in FIG. 2 is described specifically in respect of one of the servers 108, analogous versions of the system may also be used for the user devices 104 and for the system terminals 110.

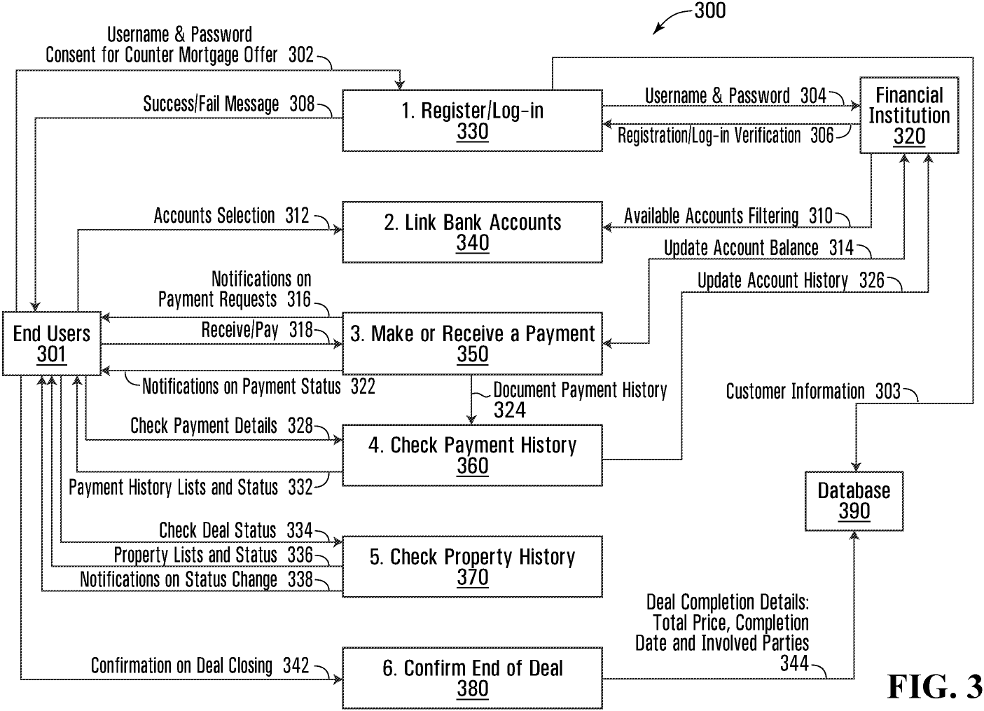

In FIG. 3, a data flow diagram 300 is provided according to an example embodiment. Key interactions between end users 301 and system and data management (in this case provided through a financial institution 320) are illustrated through the following steps:
1. registration/login (block 330);
2. linkage of bank accounts (block 340)
3. making or receiving a payment (block 350);
4. checking payment history (block 360);
5. checking property history (block 370); and
6. confirming the end of a deal (block 380).

More particularly, at block 330 an end user 301 registers or logs in to the system via a system terminal 110 (shown in FIG. 1) (arrow 302). To register or log in, the end user 301 supplies login credentials in the form, for example, of a username and password (arrow 302). The credentials are sent to the financial institution 320 (arrow 304) and, more particularly, to the financial institution’s 320 data center 106 (arrow 304) which provides online banking functionality. The system terminal 110 also sends the login credentials to a database 390 for storage. The financial institution 320 confirms registration or login (arrow 306) to the system terminal 110, which relays a success or fail message to the end user 301 as appropriate (arrow 308).

After logging in, at block 340 the end user 301 links bank accounts held at the financial institution 320 for use with the system. The system terminal 110 receives a list of available accounts from the financial institution 320 (arrow 310) and accepts input from the end user 301 as to which of those accounts are to be linked (arrow 312).

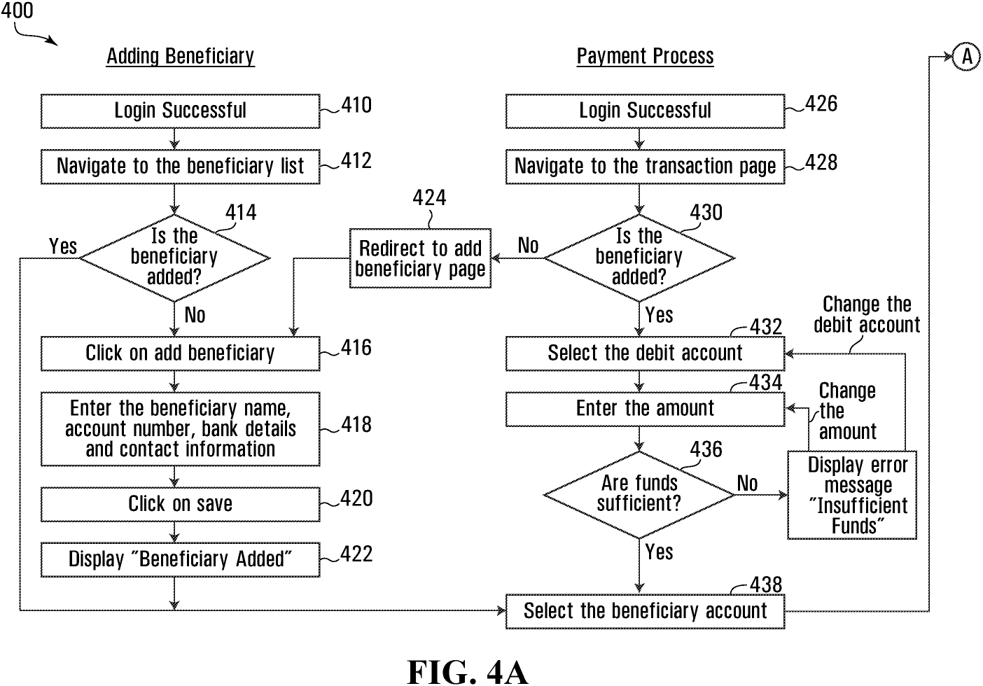

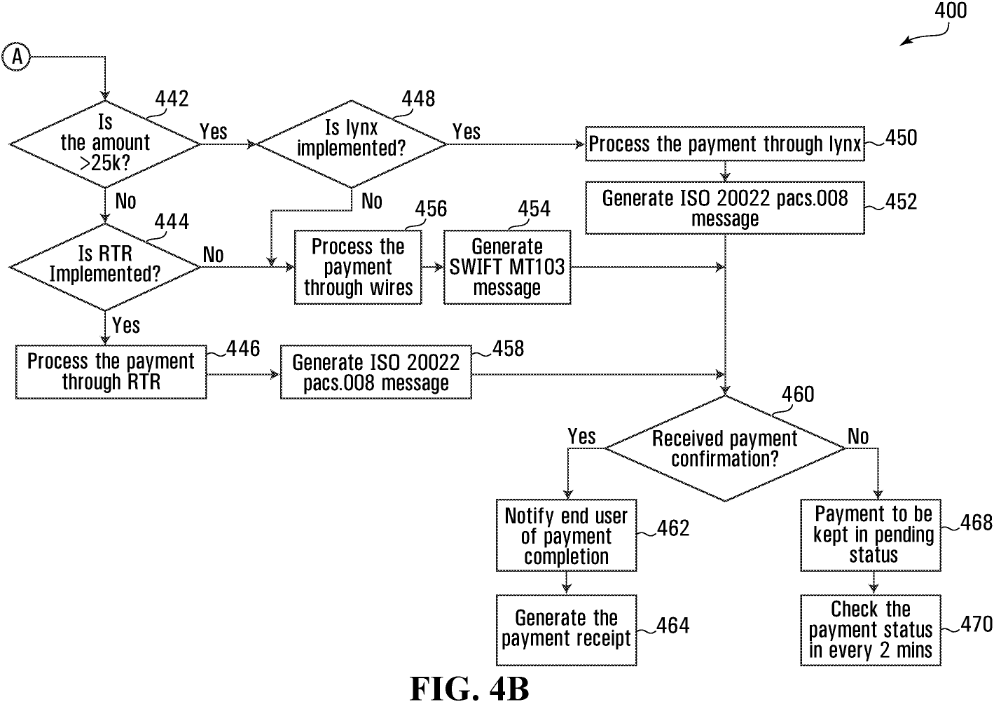

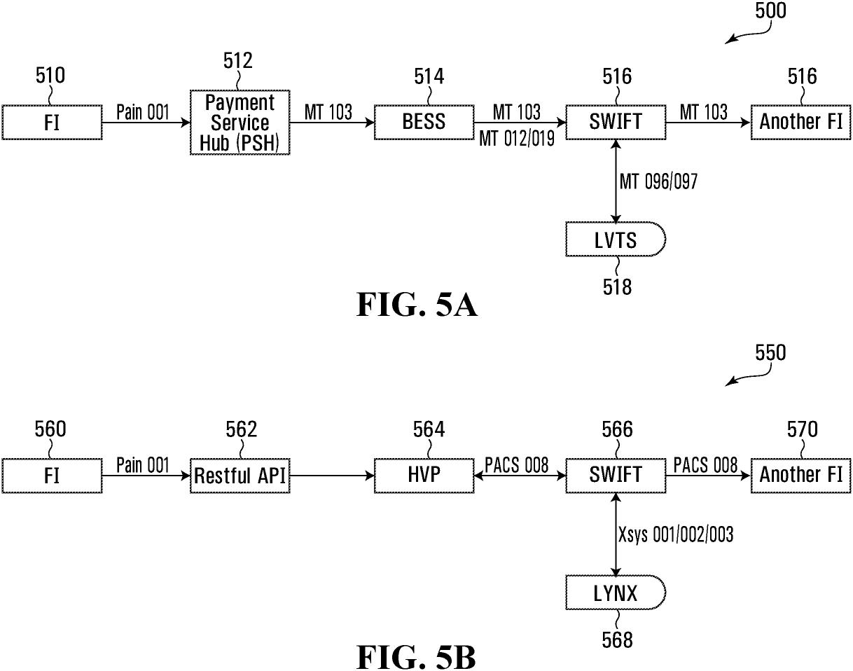

The end user 301 subsequently makes or receives a payment using at least one of those linked accounts at block 350. This is discussed in further detail below in respect of FIGS. 4A, 4B, 5A, and 5B. The system terminal 110 receives updated an updated account balance for the linked accounts (arrow 314), provides to the end user 301 notification on payment requests (arrow 316) and/or payment status (arrow 322), and also receives instructions from the end user 301 to actually approve receipt of a payment (e.g., from the buyer in a real estate transaction where the end user 301 is the seller) and/or to make a payment (e.g., to the seller in a real estate transaction where the end user 301 is the buyer) (arrow 318).

The system terminal 110 documents payment history (arrow 324) and then, at block 360, the end user 301 checks payment history. The system terminal 110 receives an updated account history (arrow 326) in respect of the account from which the payment was made or to which the payment was deposited, following which the end user 301 checks payment details (arrow 328) and in response receives payment history lists and status from the system terminal 110 (arrow 332). While FIG. 3 shows the document payment history being retained within the system, additionally or alternatively the document payment history may be stored at the financial institution 320. Additionally, while FIG. 3 shows payment history being checked at block 360, in at least some alternative embodiments this action may be omitted.

After checking the payment history, the end user 301 checks the property history at block 370. More particularly, the end user 301 inquires as to deal status (arrow 334) in response to which the end user 301 receives property lists and status (arrow 336) and notifications on any status change (arrow 338). For example, the end user 301 may receive from the system terminal 110 at arrow 336 a list of the property(ies) to be conveyed in the real estate deal and whether title to the property(ies) has been conveyed yet, and at arrow 338 push notifications when title to that property(ies) has been conveyed.

Once title to the property(ies) has transferred, the end user 301 confirms the end of the deal at block 380. The end user 301 provides the system terminal 110 with this confirmation (arrow 342), which then stores pertinent deal completion details such as total price, completion date, and identity of the involved parties in the database 390 (arrow 344).

In the context of a real estate transaction, an end user 301 may be the buyer, the seller, the realtor, or the lawyer acting as an intermediary. FIG. 3 depicts data flow when the end user 301 is a buyer, seller. The data flow when the end user 301 is a lawyer is identical to that shown in FIG. 3, except there is no need to provide consent for a counter mortgage offer (arrow 302). The data flow when the end user 301 is a realtor is identical to that shown in FIG. 3, except there is also no need to provide consent for a counter mortgage offer (arrow 302), and instead of receiving only a notification on payment requests (arrow 316), the realtor actually makes or receives the payment requests.

In FIGS. 4A and 4B, a payment process flow diagram 400 is provided according to an embodiment. As discussed in respect of FIG. 3 above, an end user 110 may perform the method depicted by the flow diagram 400 using a system terminal 110, which can communicate with a financial institution’s 320 data center 106 accordingly.

In the flow diagram 400, blocks 410, 412, 414, 416, 418, 420, and 422 are directed at adding a beneficiary who is to receive a payment. The end user 110 first logs in (block 410) and navigates to a beneficiary list (block 412). If the beneficiary has not yet been added to the beneficiary list (block 414), the end user 110 clicks on “Add beneficiary” on the system terminal 110 (block 416) and enters the beneficiary name, account number, bank details and contact information (block 418). This information may then be pre-verified using various means and error correction permitted (not shown), prior to saving (block 420) and showing the beneficiary as added (block 422). After the beneficiary has been added, or if the end user 110 determines that no beneficiary is to be added at block 414, the end user 110 proceeds to block 438 as described further below.

To initiate a payment, the end user 110 may log in to the system (if not already logged in) at block 426, navigate to a transaction page (block 428), and be again presented with the option to add a beneficiary (block 430). If the end user wishes to add a beneficiary the system terminal 110 redirects them to the “Add beneficiary” page (block 424), and the end user 110 is directed to block 416 to proceed as described above.

If no beneficiary is to be added, through the transaction page the end user 110 selects the account to be debited for the payment (block 432) and enters the amount of the payment (block 434). There may be a verification step at this stage also to confirm that sufficient funds are in the account (blocks 436 and 440), with the system terminal 110 requiring the end user 110 to either change the amount or change the debit account if there are insufficient funds. Once sufficient funds are verified, the end user 110 selects the account of the beneficiary that is to receive the payment (block 438).

Payment channels may be selected at this point. Generally speaking, payment through Lynx, Real Time Rail (RTR), or Electronics Fund Transfer (EFT) (i.e., a wire transfer) may be selected. In the particular example of FIG. 4B, if the amount to be paid is more than $25,000 (block 442) and Lynx is implement (block 448), then the payment is processed through Lynx (block 450). If the amount to be paid is less than $25,000 (block 442) and RTR is implemented (block 444), then the payment is processed through RTR (block 446). And if neither Lynx nor RTR is available, then the payment is processed as a wire transfer (block 456). Different variations are possible in different embodiments. For example, in at least some other embodiments EFT may be used as a default option.

If payment is initiated through Lynx or RTR, then an ISO 20022 pacs.008 message is generated following processing of the payment (blocks 452 and 458). If payment is initiated through EFT (wire), then a SWIFT MT103 message is generated (block 454). These are messages automatically generated once a payment is initiated by the independent payment channel systems (e.g., Lynx or RTR) themselves. Such messages pass through the worldwide SWIFT gateway system and meet international messaging standards. Once payment confirmation is received through whichever system (block 460), the end user 110 is notified (block 462) and a payment receipt is generated (block 464). Until payment confirmation is received, the payment is kept in a “pending” status (block 468), which may be checked at intervals until completed (block 470).

FIGS. 5A and 5B illustrate first and second messaging flows 500, 550 through the SWIFT gateway for either EFT/SWIFT messaging (using the Large Value Transaction Service [LVTS] for large payments) (first messaging flow 500); or ISO 20022 messaging (using Lynx for large payments) (second messaging flow 550).

In the first messaging flow 500, a financial institution 510 making the payment sends a PAIN 001 message, which is an ISO 20022 message, to a payment service hub (PSH) 512. The PSH 512 sends an MT 103 payments confirmation message to BESS 514, which is a global payments hub. BESS 514 sends another MT 103 payments confirmation message to the SWIFT system 516, which confirms to the beneficiary’s financial institution 520 that the payment has been received and liaises with LVTS 518 via MT 096/097 messages to process the payment.

In the second messaging flow 550, a financial institution 560 making the payment sends a PAIN 001 message to a RESTful API 562, which communicates with a high value payments (HVP) service 564. The HVP service 562 sends a PACS 008 message to the SWIFT system 566, which confirms to the beneficiary’s financial institution 570 that the payment has been received and liaises with Lynx 568 via Xsys 001/002/003 messages to process the payment.

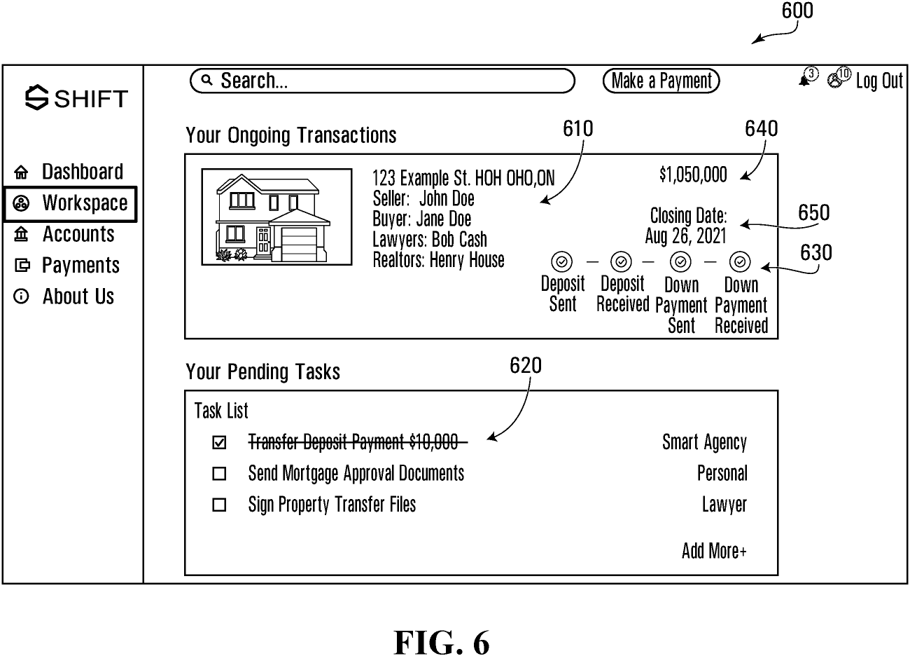

The portal for real estate transactions through which the payment functionality is accessed is discussed below in respect of FIGS. 6 to 12. Preferably, the portal provides a workspace and dashboard through which a real estate transaction can be created and monitored. The portal may be displayed to the end user 301 via the system terminal 110. As shown in FIG. 6, the transaction particulars 610 on one page 600 of the portal may include address, seller, buyer, and representative lawyer(s) and realtor(s). The purchase price 640 may be included as well as the closing date 650. Certain embodiments may include pending tasks 620 in the transaction (updated manually or automatically, with completed task(s) crossed out as shown in FIG. 6). Of note, the screen includes a graphical status indicator 630 showing the status of payments in the transaction (in FIG. 6 shown as unlit - indicating no payments have been initiated or completed).

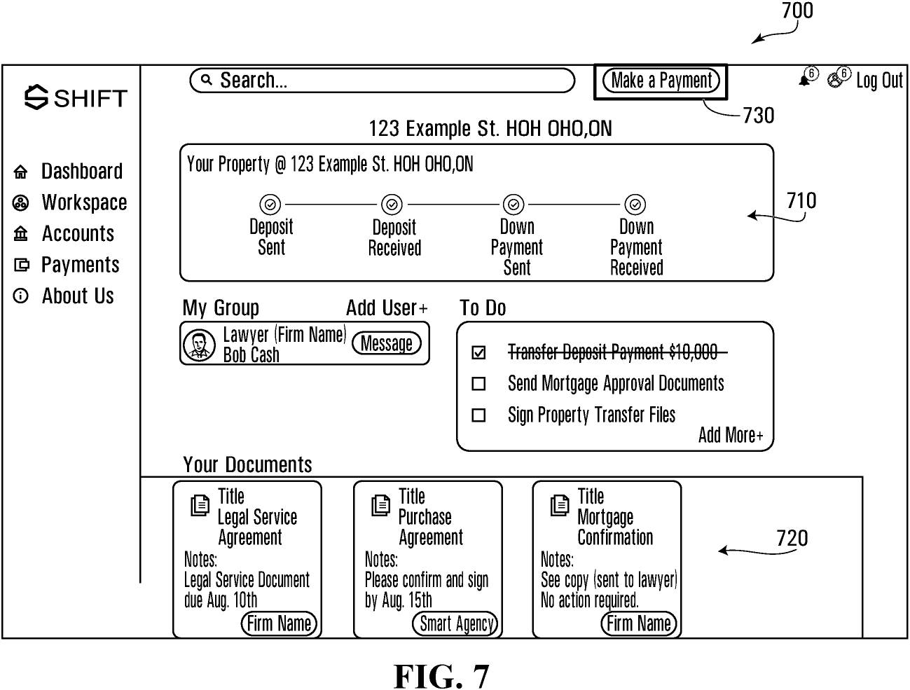

In FIG. 7, a workspace is shown another page 700 of the portal in which other details of the transaction are indicated and access may be provided to documents 720 relevant to the transaction. The portal may include functionality to create, edit and sign such documents as well as track the status of documents to be generated, amended or signed by other parties. The screen may include an option to “Make a Payment” by clicking a button 730.

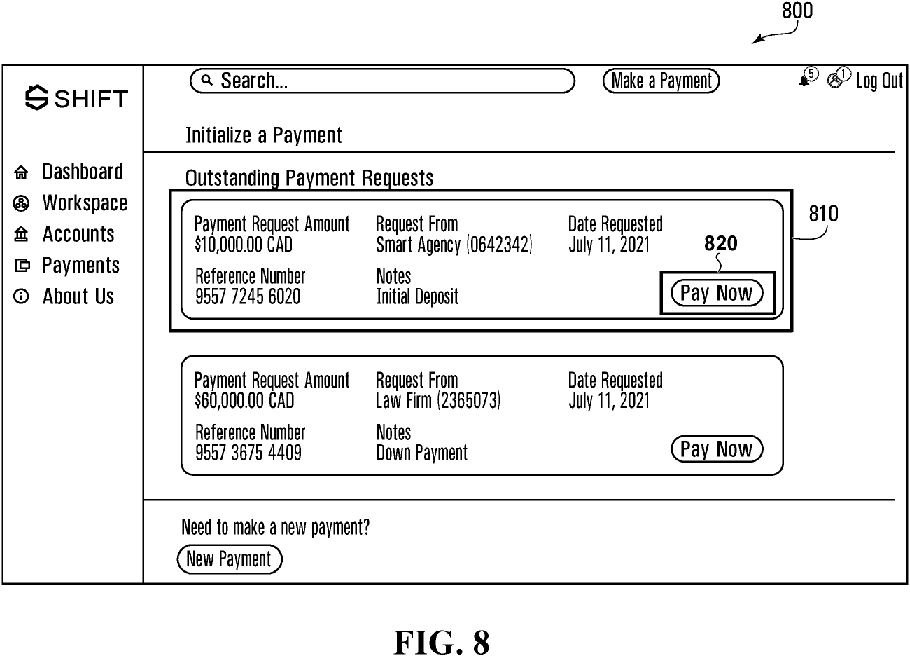

As shown in FIG. 8, a payment initialization screen 800 may be provided (e.g. responsive to the “Make a Payment” button 730 in FIG. 7). This includes particulars of a payment request 810 which may have been prepared by another party (e.g. a lawyer in the transaction) and are prepopulated for the end user 301 (in this example, the payor) to indicate a command to “Pay Now” 820. The payment request may be linked to pre-registered (and optionally pre-verified) account details, which may also have been pre-verified to contain sufficient funds for the payment as described above in respect of FIGS. 4A and 4B. In this case, two payment requests are shown: one for an initial deposit and one for a down payment. These may be staged so that the request can only be accessed once the transaction is at a stage where the payment is required. (Further, the processing of the payment, even once initialized by the payor, may be deferred to a particular date if necessary for the transaction requirements.)

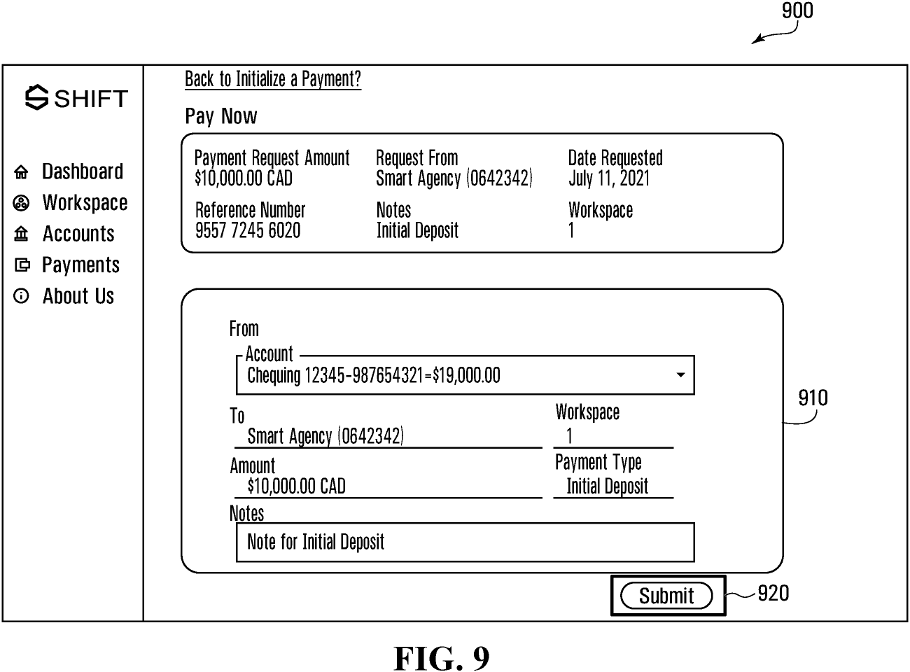

FIG. 9 illustrates a sample payment screen 900 (here, taking the layout form of a cheque) wherein the beneficiary (in this example, the payee), payment amount and payment type are prepopulated from the payment request 910. To initiate the payment, a “Submit” option 920 is provided. Following this initiation of payment, a payment initiated confirmation message or screen may be displayed to the payor (not shown).

At this point, the portal through one or more payment APIs initiates an actual payment out of the account specified in the amount specified which is sent through a digital channel. For instance, in an ISO payment channel, a PAIN 001 message may be generated, which indicates “PAyment INitiated”.

A sample PAIN.001 message follows which corresponds to the example payment initiated in FIG. 9:

<Sw:FileactRequest> <Sw:RequesterDN>o=GOOGUS66,o=swift</Sw:RequesterDN> <Sw:ResponderDN>ou=ngmacug,o=royccat2,o=swift</Sw:ResponderDN> <Sw: ServiceName>roycca.ng.fa! p</Sw: ServiceName> <Sw:RequestType>pain.001.001.03</Sw:RequestType> <Sw:FileName>dpain.001.001.03</Sw:FileName> <Sw:FileDescription>XGZOIS020022 [EPP [ SAG[TEST</Sw:FileDescription> <Sw:FileInfo>SwCompression=none</Sw:FileInfo> <Sw: TransferRef>SNL31791 D 11241006789000543 S</Sw: TransferRef> <Sw: SWIFTDateTime>2020-1 0-08T 12: 06: 50Z </Sw: SWIFTDateTime> </Sw:FileactRequest> <Document xmlns:xsi="http://www.w3 .org/2001/XMLSchema-instance" xmlns:xsd="http://www.w3 .org/2001/XMLSchema" xmlns="urn:iso: std: i so: 20022: tech: x sd: pain. 00 1.00 1.03 <CstmrCdtTrfInitn> <GrpHdr> <MsgId> 1602175399407</MsgId> <CreDtTm>2020-10-08T08:56:32.01</CreDtTm> <NbOfTxs>1</NbOfTxs> <CtrlSum>10000</CtrlSum> <InitgPty> <Id> <OrgId> <BICOrBEI>ROYCCAT2</BICOrBEI> </OrgId> </Id> </InitgPty> </GrpHdr> <PmtInf> <PmtInfId>1</PmtInfId> <PmtMtd>TRF</PmtMtd> <PmtTpInf> <SvcLvl> <Prtry>URGP</Prtry> </SvcLvl> </PmtTpInf> <ReqdExctnDt>2020-10-08</ReqdExctnDt> <Dbtr> <Nm>WIRE01 TC016</Nm> <PstlAdr> <StrtNm>Front Street West</StrtNm> <BldgNb>315</BldgNb> <PstCd>M5J 2J5</PstCd> <TwnNm>TORONTO</TwnNm> <CtrySubDvsn>ON</CtrySubDvsn> <Ctry>CA</Ctry> <AdrLine>Empire Building</AdrLine> <AdrLine>17th Floor, Pillar J15</AdrLine> <AdrLine>NSWires Debtor Address Line 3</AdrLine> <AdrLine>NSWires Debtor Address Line 4</AdrLine> </PstlAdr> </Dbtr> <DbtrAcct> <Id> <Othr> <Id>000024061560</Id> </Othr> </Id> <Ccy>CAD</Ccy> </DbtrAcct> <DbtrAgt> <FinInstnId> <BIC>ROYCCAT2</BIC> </FinInstnId> </DbtrAgt> <CdtTrfTxInf> <PmtId> <EndToEndId>75399407</EndToEndId> </PmtId> <Amt> <InstdAmt Ccy="CAD">26000</InstdAmt> </Amt> <ChrgBr>CRED</ChrgBr> <CdtrAgt> <FinInstnId> <BIC>NOSCCATT</BIC> </FinInstnId> </CdtrAgt> <Cdtr> <Nm>BRR Architecture Inc</Nm> <PstlAdr> <StrtNm>6700 ANTIOCH PLAZA STE 300</StrtNm> <PstCd>66204</PstCd> <TwnNm>MERRIAM</TwnNm> <CtrySubDvsn>KS</CtrySubDvsn> <Ctry>CA</Ctry> <AdrLine>6700 ANTIOCH PLAZA STE 300</AdrLine> </PstlAdr> <Id> <OrgId> <Othr> <Id>0005127046</Id> </Othr> </OrgId> </Id> </Cdtr> <CdtrAcct> <Id> <Othr> <Id>1091099</Id> </Othr> </Id> <RmtInf> <Ustrd>Initial Deposit</Ustrd> </RmtInf> </CdtrAcct> </CdtTrfTxInf> </PmtInf> </CstmrCdtTrfInitn> </Document>

In the above PAIN 001 message, the first 12 lines represent the message header. The message type identifier (PAIN.001.001.03) is indicated in line 14. Line 17 indicates a unique identifier for the message. Line 18 indicates the creation date and time. Line 19 indicates the number of transactions in the message. Line 20 indicates the total sum of the transactions. Code “TRF” in line 31 indicates that the payment method is a Transfer Advice. The field <Prtry> in line 34 indicates an Urgent Payment (URGP). The requested execution date in field <ReqdExctnDt> is 2020-10-08. Next, the debtor information and details are provided as well as the debit account details and debtor bank (through its Branch Identification Code [BIC]). Next, the instructed currency and amount are provided, the charge bearer is indicated (here, Creditor [CRED]) as well as the credit bank (through its BIC), the creditor information, and account.

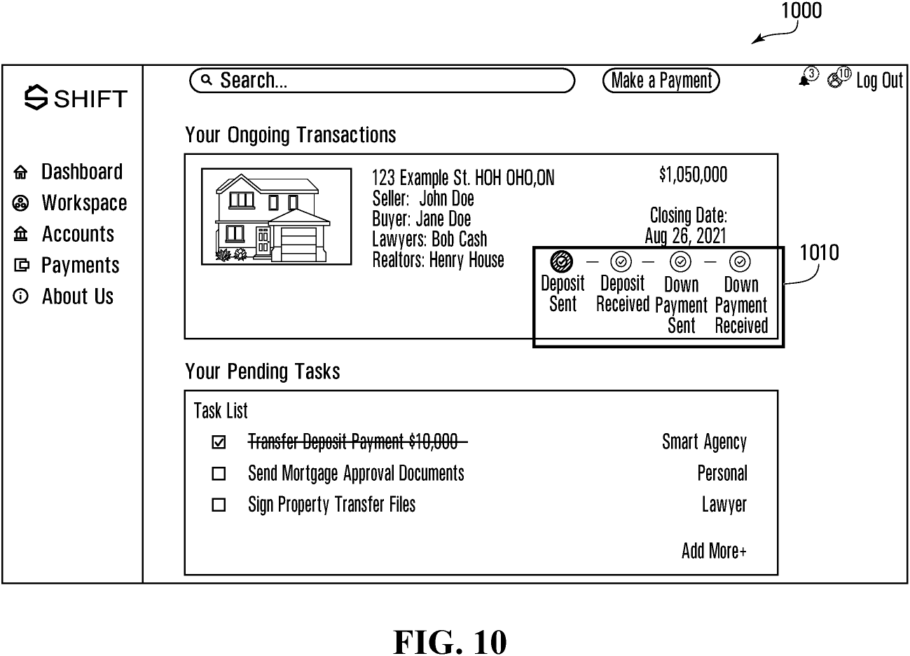

Responsive to the PAIN 001 message in this case, as shown in the screen 1000 in FIG. 10, the “Deposit Sent” symbol on the graphical status indicator 1010 is now lit (colour changed).

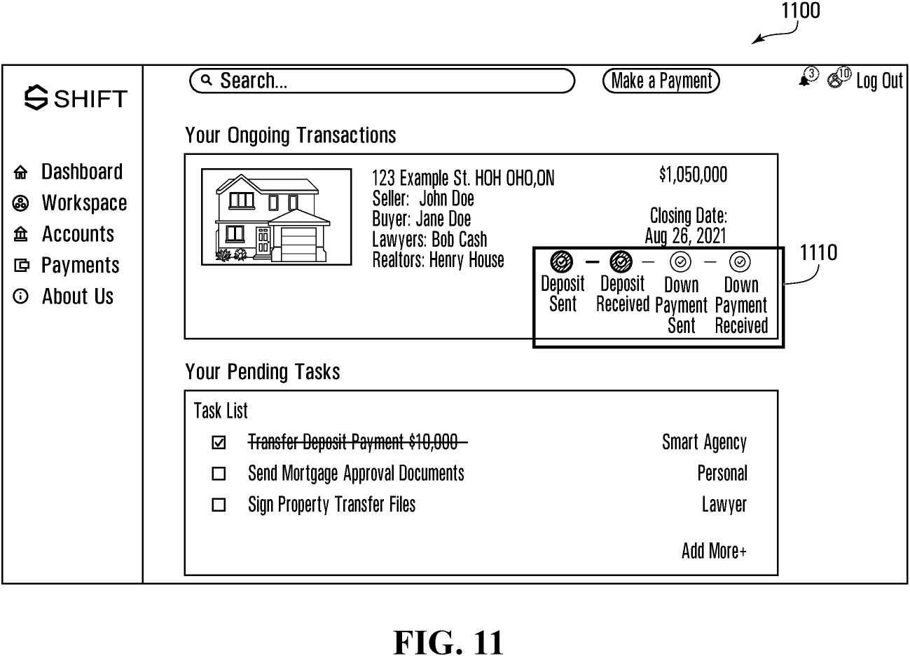

The “Deposit Received” symbol on the graphical status indicator 1110 is shown lit (colour changed) in the sample screen 1100 shown in FIG. 11. This is responsive to a second message, in this case PAIN 002 message, which is only received once the payment message has been confirmed by both financial institutions (i.e., the financial institution of the payor, and the financial institution of the payee).

A sample PAIN 002 message follows:

<Document xmlns="urn:iso:std:iso:20022:tech:xsd:pain.002.001.03> <CstmrPmtStsRpt> <GrpHdr> <MsgId>5685417789</MsgId> <CreDtTm>2021-04-27T12:50:50.684-04:00</CreDtTm> <InitgPty> <Id> <OrgId> <BICOrBEI>ROYCCAT2</BICOrBEI> </OrgId> </Id> </InitgPty> <DbtrAgt> <FinInstnId> <BIC>ROYCCAT2</BIC> </FinInstnId> </DbtrAgt> <CdtrAgt> <FinInstnId> <BIC>NOSCCATT</BIC> </FinInstnId> </CdtrAgt> </GrpHdr> <OrgnlGrpInfAndSts> <OrgnlMsgId>1602175399407</OrgnlMsgId> <OrgnlMsgNmId>pain.001.001.03</OrgnlMsgNmId> <OrgnlNbOfTxs>1</OrgnlNbOfTxs> <OrgnlCtrlSum>1</OrgnlCtrlSum> <GrpSts>ACTC</GrpSts> </OrgnlGrpInfAndSts> <OrgnlPmtInfAndSts> <OrgnlPmtInfId>02</OrgnlPmtInfld> <TxInfAndSts> <OrgnlEndToEndId>75399407</OrgnlEndToEndId> <TxSts>ACTC</TxSts> <StsRsnInf> <Orgtr> <Id> <OrgId> <BICOrBEI>ROYCCAT2</BICOrBEI> </OrgId> </Id> </Orgtr> <Rsn> <Prtry>CLRG</Prtry> </Rsn> </StsRsnInf> <OrgnlTxRef> <Amt> <InstdAmt Ccy="CAD">10000</InstdAmt> </Amt> <ReqdExctnDt>2020-10-08</ReqdExctnDt> <PmtTpInf> <SvcLvl> <Prtry>URGP</Prtry> </SvcLvl> </PmtTpInf> <PmtMtd>TRF</PmtMtd> <Dbtr> <Nm>WIRE01 TC016</Nm> <PstlAdr> <StrtNm>Front Street West</StrtNm> <BldgNb>315</BldgNb> <PstCd>M5J 2J5</PstCd> <TwnNm>TORONTO</TwnNm> <CtrySubDvsn>ON</CtrySubDvsn> <Ctry>CA</Ctry> <AdrLine>Empire Building</AdrLine> <AdrLine>17th Floor, Pillar J15</AdrLine> <AdrLine>NSWires Debtor Address Line 3</AdrLine> <AdrLine>NSWires Debtor Address Line 4</AdrLine> </PstlAdr> </Dbtr> <DbtrAcct> <Id> <Othr> <Id>000024061560</Id> </Othr> </Id> </DbtrAcct> <DbtrAgt> <FinInstnId> <BIC>ROYCCAT2</BIC> </FinInstnId> </DbtrAgt> <CdtrAgt> <FinInstnId> <BIC>NOSCCATT</BIC> </FinInstnId> </CdtrAgt> <Cdtr> <Nm>BRR Architecture Inc</Nm> <PstlAdr> <StrtNm>6700 ANTIOCH PLAZA STE 300</StrtNm> <PstCd>66204</PstCd> <TwnNm>MERRIAM</TwnNm> <CtrySubDvsn>KS</CtrySubDvsn> <Ctry>CA</Ctry> <AdrLine>6700 ANTIOCH PLAZA STE 300</AdrLine> </PstlAdr> <Id> <OrgId> <Othr> <Id>0642342</Id> </Othr> </OrgId> </Id> </Cdtr> <CdtrAcct> <Id> <Othr> <Id>4003612</Id> </Othr> </Id> </CdtrAcct> </OrgnlTxRef> </TxInfAndSts> </OrgnlPmtInfAndSts> </CstmrPmtStsRpt> </Document>

The above PAIN 002 message includes a header, specifying its schema. It further includes a unique identifier for each message, and an indication of the payment creation, date and time (line 5). The debit and credit side banks are identified. The original PAIN 001 message is identified in lines 24-28 (and its unique identifier is referenced). The transaction status is shown in the field <TxSts>, here indicating “ACTC” (Accepted).

Using messages such as the sample PAIN 001 and PAIN 002 messages, the present system can identify the status of the payment (transfer of funds) immediately using the bankaccessible data stream. Although other payment channels use other messaging, which may or may not be field-separated as the above examples, the status can likewise be decoded and automatically used to trigger a change in the graphical status indicator. Lynx and LVTS are particular large value channels for ISO 20022 and SWIFT standards respectively. There are various advantages of these large value channels for real estate transactions.

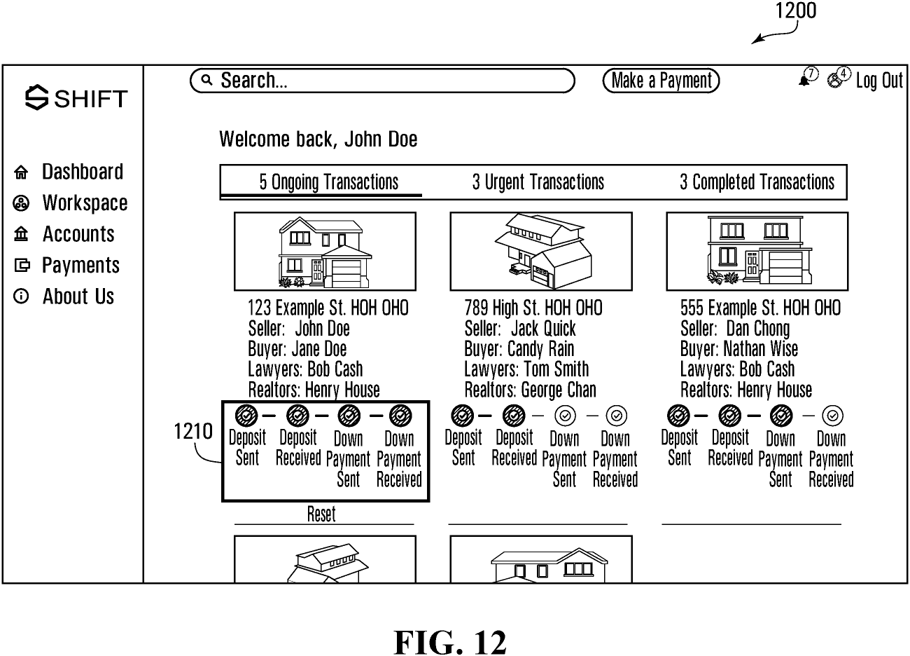

FIG. 12 illustrates a sample representative view 1200 showing multiple transactions in progress. The status indicator 1210 for 123 Example St. is shown indicating that both deposit and down payment transfers were initiated and received. The difference in messaging between a deposit and a down payment may be decoded by the system. As shown in the foregoing screen shots in FIGS. 6-12, the payment channel messaging itself is preferably hidden from the end users, although it is decoded into human readable (and graphical indicator) terms in real time from those messages in the back end. This avoids the need to manually rekey such status information or have human intervention, leading to doubt, and the possibility of error and delay.

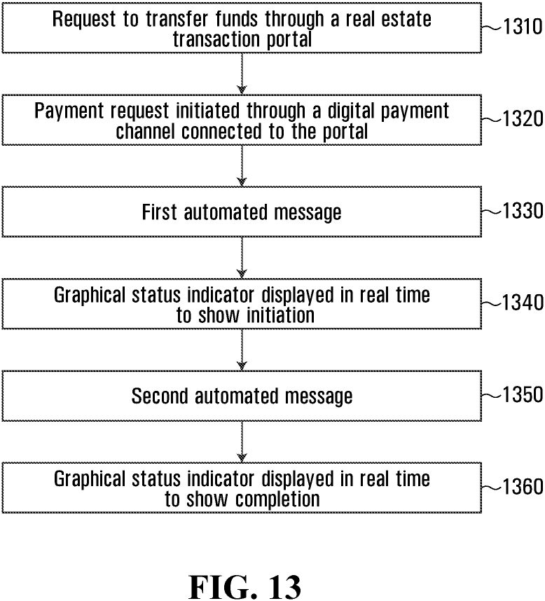

FIG. 13 provides a summary of a method 1300 for digital status tracking of funds, according to an example embodiment. To begin, a request for funds transfer is received through a real estate transaction portal (block 1310). The payment request is initiated through a digital payment channel connected to (in communication with) the portal (block 1320). A first automated message is received (see, e.g., PAIN 001 described above) (block 1330). A graphical status indicator is displayed in real time on the portal to show the initiation (block 1340). This graphical status indicator is updated in real time (block 1360) to show completion of the payment once the second automated message is received (see, e.g., PAIN 002 described above) (block 1350).

Various types of graphical status indicators may be provided. Although radiobutton style indicators are shown along a simplified timeline in the sample screen shots, it will be appreciated that this could likewise be any type of status bar or other type of graphical symbol readily understood to end users. Preferably, the symbols use at least one colour that is converted (or filled in) when the status is updated. There may be other status indications besides “initiated” and “confirmed” or “received”. For example, these could include “delayed” or “error” messages or other “flagged” type indications. These may be generated in response to payment channel messages or in the absence of payment channel messages (e.g. if a period of time has elapsed without a message or an expected deadline has passed). Further, the system may provide further detail on the status as determined from the payment messages, limited only by the information conveyed in such messages. In addition to PAIN 001 and PAIN 002 messages, other payment messages may be received and decoded by the system. Further, the decoding may include filling in truncated information based on what is already known from the transaction, account and party particulars. This may be particularly relevant for traditional EFT (SWIFT) messages, which included character limits.

It will be appreciated that different graphical status indicators may be provided to each party (or representative) separately. For example, errors may be flagged differently for payees vs. payors and different corrective or informative options may be presented.

Further, it will be appreciated that in addition to graphical status indicators, status updates may directly notified to end users using various communication channels, such as email or text message, or by providing notifications in another application, such as an online banking application.

The foregoing examples in FIGS. 6-12 are illustrative of an embodiment within a multi-functional real estate transaction portal (everything in one place). It will be appreciated that the payment status tracker may be provided as a standalone application, and the end users need not include all parties described above, but may be limited in some embodiments to just the payor or just the payee, as the case may be.

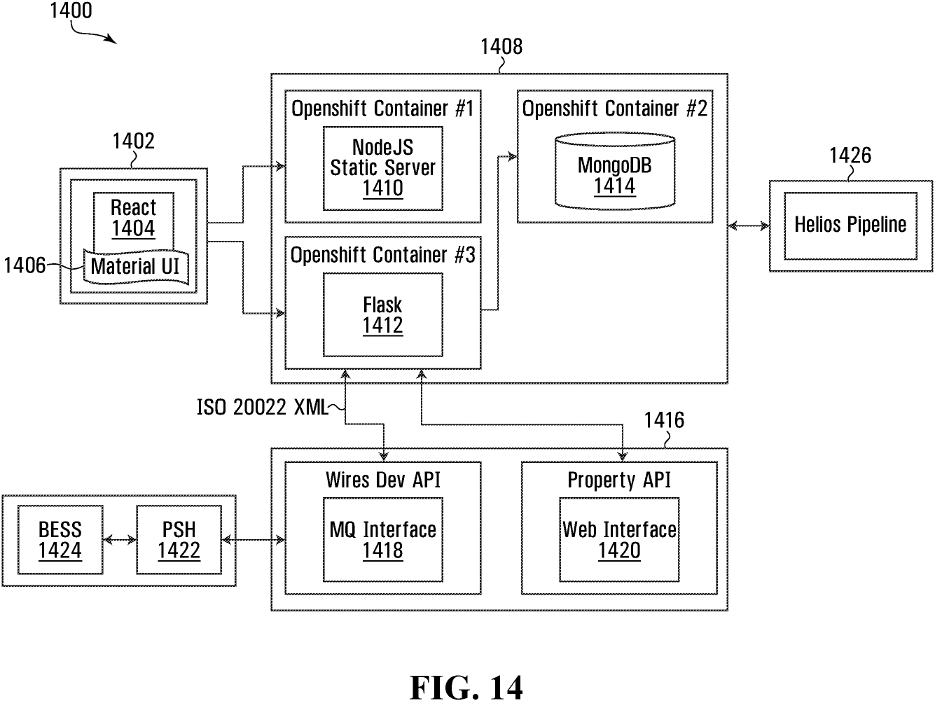

Referring now to FIG. 14, there is shown a block diagram 1400 of the system for digital status tracking of funds illustrating the technology stack used to implement the system, according to an example embodiment. More particularly, a browser 1402 runs on the system terminal 110 and is used to display the interfaces as shown in FIGS. 6-12. The browser 1402 implements the user interface by running React.JS 1404 and the Material UI component library 1406.

Running in the data center 106 are three OpenShift™ clusters 1408: a first cluster that runs a NodeJS static server 1410; a second cluster that runs a database 1414; and a third cluster that run a backend in the form of a Flask™ application 1412. The NodeJS static server 1410 comprises the computer program code for the front end of the system that is depicted on the system terminal 110 by virtue of being downloaded to and executed using the browser 1402. The Flask™ application 1412 interacts with various APIs 1416, as described further below, and also with the database 1414. The database 1414 may be implemented using, for example, MongoDB™ and is used to store application details such as components states, account information, and the like. Collectively, the functionality performed by the three clusters may be performed, for example, by the financial institution 320 in the context of FIG. 3. The clusters 1408 are connected to a Helios™ DevOps system 1426 for deployment.

The APIs 1416 comprise an IBM™ Message Queue (MQ) interface 1418 for wire transfers (analogous APIs may be used for LVTS and Lynx) and a property pricing API 1420 implemented using a web interface to make housing price predictions to aid end users 301, such as realtors, in deciding on what purchase price to offer in respect of a piece of real estate. For example, the property pricing API 1420 may accept inputs in the form of property address; dwell style; dwell type; and property age, and output a predicted price; a predicted price confidence level; a maximum valuation price; and a minimum valuation price. The MQ interface 1418 sends messages used for wire transfers to a payment service hub (PSH) 1422 and a global payments hub, BESS 1424, as described above in respect of FIG. 5A.

Real estate transactions have been described throughout. However, as mentioned above the systems and methods described herein may be applied to other types of transactions between parties involving payment of funds. The present disclosure is not intended to be limited necessarily to real estate transactions.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for tracking funds in a transaction using a real estate transaction portal, comprising:
through an interface of the real estate transaction portal, accepting a request from a pre-registered buyer to transfer funds to a pre-registered beneficiary, the funds being in settlement of at least a portion of the real estate transaction;
initiating a corresponding payment request through one of a plurality of digital payment channels;
on receipt of a first automated message through the one of the plurality of digital payment channels, decoding the first automated message as a confirmation of the initiation of the payment request;
in real time, displaying to the pre-registered buyer and the pre-registered beneficiary a graphical status indicator showing the initiation;
on receipt of a second automated message through the one of the plurality of digital payment channels, decoding the second automated message as a completion of the payment request; and
in real time, modifying the graphical status indicator to display to the pre-registered buyer and the pre-registered beneficiary that the payment has been completed.

2. The method of claim 1, wherein the payment channel is selected from wire payment, Real Time Rail, Lynx, and Large Value Transaction Service (LVTS).

3. The method of claim 1, wherein the automated messages are in SWIFT or ISO encoding.

4. The method of claim 3, wherein the first automated message comprises a PAIN.001 message and the second automated message comprises a PAIN.002 message.

5. The method of claim 3, wherein the decoding of the first and second automated messages comprises determining the encoding of the first and second automated messages, respectively.

6. The method of claim 5, wherein the decoding of the first and second automated messages comprises parsing a string into segments.

7. The method of claim 3, wherein the decoding of the first and second automated messages comprises conversion of one encoding to another.

8. The method of claim 3, wherein the decoding of the first and second automated messages comprises conversion into a human readable message.

9. The method of claim 1, wherein the graphical status indicator comprises at least one colour.

10. The method of claim 9, wherein the colour of at least a portion of the graphical status indicator is changed or filled in as the automated messages are received.

11. The method of claim 1, further comprising displaying at least one textual message in human readable terms with the graphical status indicator.

12. The method of claim 1, further comprising receiving particulars of the real estate transaction through the interface, including a settlement amount, and pre-verifying the particulars or the settlement amount prior to allowing the funds transfer request to be received.

13. The method of claim 12, wherein the beneficiary is pre-verified by validating a link of the beneficiary to a valid bank account.

14. The method of claim 13, wherein the buyer is pre-verified by:
validating a link of the buyer to a valid bank account; and
validating that the buyer’s bank account includes sufficient funds to cover the settlement amount.

15. The method of claim 14, wherein the request to transfer funds is signaled by response to a prepopulated request form, the form comprising the settlement amount.

16. The method of claim 15, wherein the form further comprises prepopulated references to the buyer’s bank account and the beneficiary’s bank account.

17. The method of claim 1, further comprising selecting the one of the plurality of digital payment channels based on an amount of the funds.

18. The method of claim 1, wherein the interface of the real estate transaction portal is displayed on a first system terminal, and the graphical status indicator is displayed to the pre-registered buyer and pre-registered beneficiary on respective second and third system terminals.

19. A system for tracking funds in a transaction using a real estate transaction portal, comprising:
first, second, and third system terminals; and
one or more servers configured to perform a method comprising:
through an interface of the real estate transaction portal displayed on the first system terminal, accepting a request from a pre-registered buyer to transfer funds to a pre-registered beneficiary, the funds being in settlement of at least a portion of the real estate transaction;
initiating a corresponding payment request through one of a plurality of digital payment channels;
on receipt of a first automated message through the one of the plurality of digital payment channels, decoding the first automated message as a confirmation of the initiation of the payment request;
in real time, displaying to the pre-registered buyer and the pre-registered beneficiary on the second and third system terminals, respectively, a graphical status indicator showing the initiation;
on receipt of a second automated message through the one of the plurality of digital payment channels, decoding the second automated message as a completion of the payment request; and
in real time, modifying the graphical status indicator to display to the pre-registered buyer and the pre-registered beneficiary that the payment has been completed.

20. A non-transitory computer readable medium having stored thereon computer program code that is executable by a processor and that, when executed by the processor, causes the processor to perform a method for tracking funds in a transaction using a real estate transaction portal, comprising:
through an interface of the real estate transaction portal, accepting a request from a pre-registered buyer to transfer funds to a pre-registered beneficiary, the funds being in settlement of at least a portion of the real estate transaction;
initiating a corresponding payment request through one of a plurality of digital payment channels;
on receipt of a first automated message through the one of the plurality of digital payment channels, decoding the first automated message as a confirmation of the initiation of the payment request;
in real time, displaying to the pre-registered buyer and the pre-registered beneficiary a graphical status indicator showing the initiation;
on receipt of a second automated message through the one of the plurality of digital payment channels, decoding the second automated message as a completion of the payment request; and
in real time, modifying the graphical status indicator to display to the pre-registered buyer and the pre-registered beneficiary that the payment has been completed.
